(19) United States
(12) Patent Application Publication
(10) Pub. No.: US 2022/0063536 A1
(43) Pub. Date: Mar. 3, 2022

(54) Child Safety Seat Assembly

(71) Applicant: Kimberly Creek, Shepherdsville, KY (US)

(72) Inventor: Kimberly Creek, Shepherdsville, KY (US)

(21) Appl. No.: 17/010,951

(22) Filed: Sep. 3, 2020

(51) Int. Cl. B60R 21/015; B60N 2/28

(52) U.S. Cl. CPC B60R 21/01546; B60N 2/2812; B60R 2022/4866; B60R 21/01566; B60R 21/01554

(57) ABSTRACT

A child safety seat assembly for alerting a user to improper use thereof includes a safety seat, which comprises a base that is engageable to a seat of a vehicle and a harness to secure a child in the safety seat. A sensor and alert module engaged to the safety seat detects positioning of a child upon the safety seat and alerts the user thereof. The sensor and alert module also detects buckling of the harness and alerts the user of a buckling failure.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to seat assemblies and more particularly pertains to a new seat assembly for alerting a user to improper use thereof.

### (2) Description of Related Art Including Information Disclosed Under 37 CFR 1.97 and 1.98

The prior art relates to seat assemblies for children in vehicles and may comprise sensors and alarms.

### BRIEF SUMMARY OF THE INVENTION

An embodiment of the disclosure meets the needs presented above by generally comprising a safety seat, which comprises a base configured to be engageable to a seat of a vehicle and a harness configured to secure a child in the safety seat. A sensor and alert module is engaged to the safety seat and is configured to detect positioning of a child upon the safety seat and to alert the user thereof. The sensor and alert module also is configured to detect buckling of the harness and to alert the user of a buckling failure.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a child safety seat assembly according to an embodiment of the disclosure.

FIG. 2 is a front view of an embodiment of the disclosure.

FIG. 3 is an in-use view of an embodiment of the disclosure.

FIG. 4 is a block diagram of an embodiment of the disclosure.

### DETAILED DESCRIPTION OF THE INVENTION

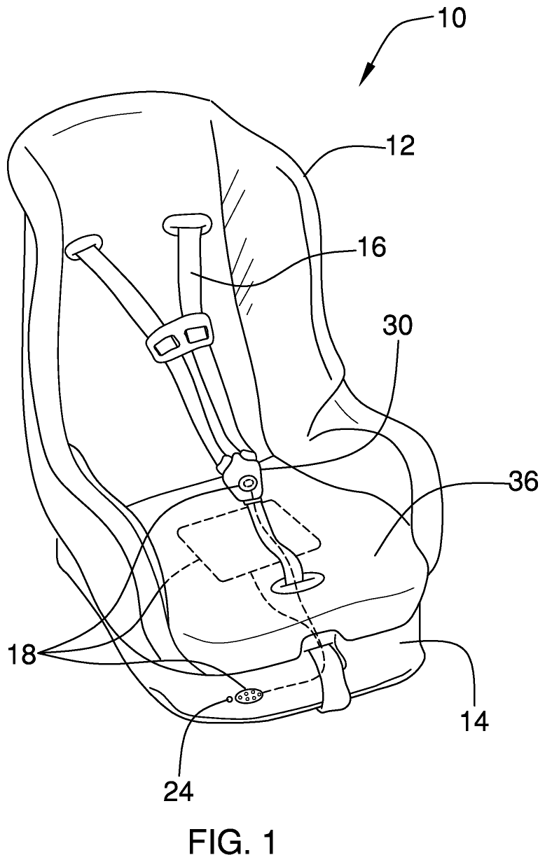

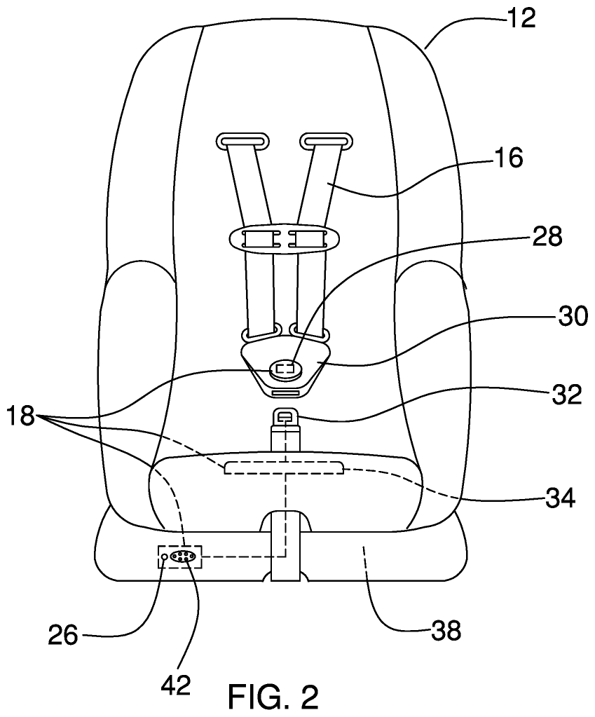

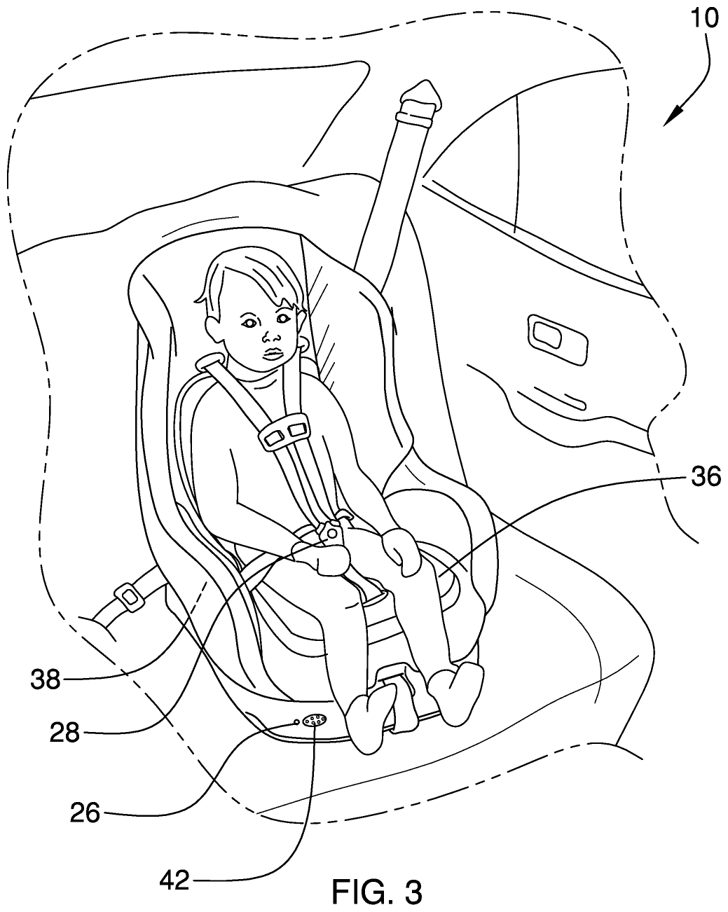

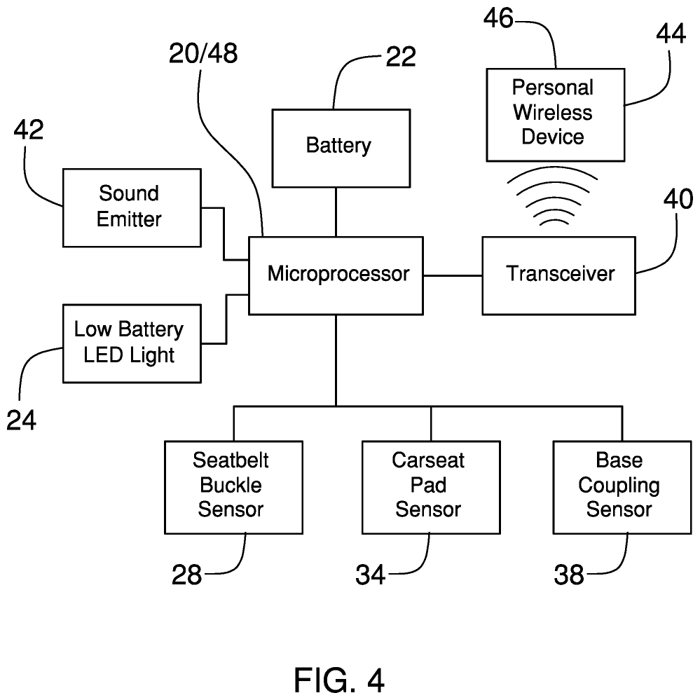

With reference now to the drawings, and in particular to FIGS. 1 through 4 thereof, a new seat assembly embodying the principles and concepts of an embodiment of the disclosure and generally designated by the reference numeral 10 will be described.

As best illustrated in FIGS. 1 through 4, the child safety seat assembly 10 generally comprises a safety seat 12, which in turn comprises a base 14 configured to be engageable to a seat of a vehicle and a harness 16 configured to secure a child in the safety seat 12.

A sensor and alert module 18 is engaged to the safety seat 12 and is configured to detect positioning of a child upon the safety seat 12 and to alert the user thereof. The sensor and alert module 18 also is configured to detect buckling of the harness 16 and to alert the user of a buckling failure. The sensor and alert module 18 also may be configured to detect coupling of the base 14 to the seat of the vehicle and to alert the user of a coupling failure.

The sensor and alert module 18 comprises a microprocessor 20, which is operationally engaged to a battery 22. An indicator 24 is engaged to the base 14 and is operationally engaged to the microprocessor 20. The microprocessor 20 is positioned to selectively actuate the indicator 24 to indicate a low charge level of the battery 22. The indicator 24 may comprise a light emitting diode 26, or other indicating means, such as, but not limited to, gauges, bar graphs, and the like.

A buckling sensor 28 is engaged to a buckle 30 of the harness 16 and is operationally engaged to the microprocessor 20. The buckling sensor 28 is configured to detect insertion of a tongue 32 of the harness 16 into the buckle 30.

An occupancy sensor 34 is engaged to a seat section 36 of the safety seat 12 and is operationally engaged to the microprocessor 20. The occupancy sensor 34 is configured to detect the positioning of the child upon the seat section 36 of the safety seat 12.

A coupling sensor 38 is engaged to the base 14 and is operationally engaged to the microprocessor 20. The coupling sensor 38 is configured to detect the coupling of the base 14 to the seat of the vehicle.

The buckling sensor 28, the occupancy sensor 34, and the coupling sensor 38 comprise components well known to those skilled in the art of sensing, such as, but not limited to, contact sensors, tension sensors, pressures sensor, proximity sensors, and the like.

At least one of a transceiver 40 and a speaker 42 is operationally engaged to the microprocessor 20, which should be interpreted to mean only a transceiver 40, only a speaker 42, or both a transceiver 40 and a speaker 42. The microprocessor 20 is positioned to selectively actuate the at least one of a transceiver 40 and a speaker 42 to alert the user to positioning of the child upon the safety seat 12, to a buckling failure, and to a coupling failure.

Alert programming code 44 positioned on an electronic device 46 of the user enables the electronic device 46 to receive and to process transmissions from the transceiver 40. The alert programming code 44 can be positioned on multiple electronic devices 46. Therefore, a parent or guardian can be alerted when the child is in the care of someone other than the parent or guardian.

The present invention also anticipates the microprocessor 20 being operationally engaged to an electronic control unit of the vehicle. Occupancy programming code 48 positioned on the microprocessor 20 enables the microprocessor 20 to actuate the at least one of a transceiver 40 and a speaker 42 to alert the user when the vehicle is turned off concurrently with the occupancy sensor 34 detecting the child in the safety seat 12.

In use, the base 14 of the safety seat 12 is engaged to the car seat and the child is positioned in the safety seat 12. The occupancy sensor 34 detects the child and signals the microprocessor 20. The tongue 32 of the harness 16 is inserted into the buckle 30. If not inserted properly, the buckling sensor 28 signals the microprocessor 20 and an alert is issued via the at least one of a transceiver 40 and a speaker 42.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be only one of the elements.

I claim:

1. A child safety seat assembly comprising:
a safety seat, the safety seat comprising a base configured to be engageable to a seat of a vehicle and a harness configured for securing a child in the safety seat; and
a sensor and alert module engaged to the safety seat and being configured for detecting positioning of a child upon the safety seat and alerting the user thereof, and for detecting buckling of the harness and alerting the user of a buckling failure.

2. The child safety seat assembly of claim 1, further including the sensor and alert module being configured for detecting coupling of the base to the seat of the vehicle and alerting the user of a coupling failure.

3. The child safety seat assembly of claim 1, wherein the sensor and alert module comprises:
a battery;
a microprocessor operationally engaged to the battery;
a buckling sensor engaged to a buckle of the harness and being operationally engaged to the microprocessor, the buckling sensor being configured for detecting insertion of a tongue of the harness into the buckle;
an occupancy sensor engaged to a seat section of the safety seat and being operationally engaged to the microprocessor, the occupancy sensor being configured for detecting the positioning of the child upon the seat section of the safety seat; and
at least one of a transceiver and a speaker operationally engaged to the microprocessor, such that the microprocessor is positioned for selectively actuating the at least one of a transceiver and a speaker for alerting the user to positioning of the child upon the safety seat and a buckling failure.

4. The child safety seat assembly of claim 3, further including an indicator engaged to the base and operationally engaged to the microprocessor, such that the microprocessor is positioned for selectively actuating the indicator for indicating a low charge level of the battery.

5. The child safety seat assembly of claim 4, wherein the indicator comprises a light emitting diode.

6. The child safety seat assembly of claim 4, further including a coupling sensor engaged to the base and being operationally engaged to the microprocessor, the coupling sensor being configured for detecting the coupling of the base to the seat of the vehicle, such that the microprocessor is positioned for selectively actuating the at least one of a transceiver and a speaker for alerting the user to a coupling failure.

7. The child safety seat assembly of claim 4, further including programming code positioned on an electronic device of the user enabling the electronic device for receiving and processing transmissions from the transceiver.

8. A child safety seat assembly comprising:
a safety seat, the safety seat comprising a base configured to be engageable to a seat of a vehicle and a harness configured for securing a child in the safety seat;
a sensor and alert module engaged to the safety seat and being configured for detecting positioning of a child upon the safety seat and alerting the user thereof, and for detecting buckling of the harness and alerting the user of a buckling failure, the sensor and alert module being configured for detecting coupling of the base to the seat of the vehicle and alerting the user of a coupling failure, the sensor and alert module comprising:
a battery,
a microprocessor operationally engaged to the battery,
an indicator engaged to the base and operationally engaged to the microprocessor, such that the microprocessor is positioned for selectively actuating the indicator for indicating a low charge level of the battery, the indicator comprising a light emitting diode,
a buckling sensor engaged to a buckle of the harness and being operationally engaged to the microprocessor, the buckling sensor being configured for detecting insertion of a tongue of the harness into the buckle,
an occupancy sensor engaged to a seat section of the safety seat and being operationally engaged to the microprocessor, the occupancy sensor being configured for detecting the positioning of the child upon the seat section of the safety seat,
at least one of a transceiver and a speaker operationally engaged to the microprocessor, such that the microprocessor is positioned for selectively actuating the at least one of a transceiver and a speaker for alerting the user to positioning of the child upon the safety seat and a buckling failure, and
a coupling sensor engaged to the base and being operationally engaged to the microprocessor, the coupling sensor being configured for detecting the coupling of the base to the seat of the vehicle, such that the microprocessor is positioned for selectively actuating the at least one of a transceiver and a speaker for alerting the user to a coupling failure; and
programming code positioned on an electronic device of the user enabling the electronic device for receiving and processing transmissions from the transceiver.
